(19) United States
(12) Patent Application Publication
(10) Pub. No.: US 2005/0128073 A1
(43) Pub. Date: Jun. 16, 2005

(54) Commercial communication system

(76) Inventors: Benton S. Coons, Prior Lake, MN (US); Kenneth J. Coons, Lakeville, MN (US); Peter Blakeley, Savage, MN (US)

Correspondence Address: MERCHANT & GOULD PC, P.O. BOX 2903, MINNEAPOLIS, MN, 55402-0903, US

(21) Appl. No.: 10/973,809

(22) Filed: Oct. 25, 2004

Related U.S. Application Data
(63) Continuation-in-part of application No. 10/883,640, filed on Jul. 1, 2004.
Application No. 10/883,640 is a continuation of application No. 10/658,113, filed on Sep. 9, 2003, now abandoned.
Application No. 10/658,113 is a continuation of application No. 09/115,988, filed on Jul. 15, 1998, now Pat. No. 6,618,582.

(51) Int. Cl. G08B 1/08

(52) U.S. Cl. 340/539.1; 340/500

(57) ABSTRACT

The disclosure relates to a commercial communications system for detecting an event, and communicating the detection of the event to a controller.

This application is a continuation-in-part of application Ser. No. 10/883,640, filed on Jul. 1, 2004, which is a continuation of application Ser. No. 10/658,113, filed on Sep. 9, 2003, which is a continuation of application Ser. No. 09/115,988, filed on Jul. 15, 1998, now U.S. Pat. No. 6,618,582.

### FIELD OF THE INVENTION

The present invention relates to commercial communication systems for detecting an event and communicating the occurrence of the event to a controller.

### BACKGROUND OF THE INVENTION

In commercial settings, it is often desirable to electronically monitor a number of different events. Example events include calls from call boxes (e.g., call boxes in stores, nursing homes, hospitals, or other settings), or the activation of detectors (e.g., smoke detectors, motion detectors, people counters, door detectors, heat detectors, flame detectors, etc.). These types of systems can often be required to process large amounts of data.

### SUMMARY OF THE INVENTION

One aspect of the present disclosure relates to a call assistance system.

Another aspect of the present disclosure relates to a commercial communication system including a device for detecting an event, and communicating the event to a controller. In certain embodiments, the system is adapted to facilitate the processing of large amounts of data.

These and various other advantages and features of novelty which characterize the invention are pointed out with particularity in the claims annexed hereto and forming a part hereof. However, for a better understanding of the invention, its advantages, and the object obtained by its use, reference should be made to the accompanying drawings and descriptive matter which form a part hereof, and in which is illustrated and described preferred embodiments of the invention.

### BRIEF DESCRIPTION OF THE DRAWINGS

In the drawings, wherein corresponding reference numerals generally indicate corresponding parts throughout the several views:

FIG. 1 is a block diagram schematically illustrating an embodiment of a system in accordance with the principles of the invention;

FIG. 2 is a block diagram schematically illustrating a call box in accordance with the principles of the invention;

FIG. 3 is a block diagram schematically illustrating a central processor in accordance with the principles of the invention; and

FIG. 4 is a block diagram schematically illustrating a floor plan of a retail business facility where a system in accordance with the principles of the invention may be used;

FIG. 5 is a schematic of an example commercial communication system in accordance with the principles of the present disclosure;

FIG. 6 is a schematic of a people counter in accordance with the principles of the present disclosure;

FIG. 7 is a flowchart illustrating operating steps for the people counter of FIG. 6;

FIG. 8 is a schematic of a remote terminal unit in accordance with the principles of the present disclosure;

FIG. 9 is a flowchart illustrating operating steps of the remote terminal unit of FIG. 8;

FIG. 10 illustrates a user interface in accordance with the principles of the present disclosure;

FIG. 11 is a schematic of a data concentrator in accordance with the principles of the present disclosure;

FIG. 12 is a state transition diagram for the data concentration of FIG. 11; and

FIGS. 13-15 jointly depict a scheme by which the data concentration of FIG. 11 may determine if a change in status occurs.

### DETAILED DESCRIPTION OF THE DRAWINGS

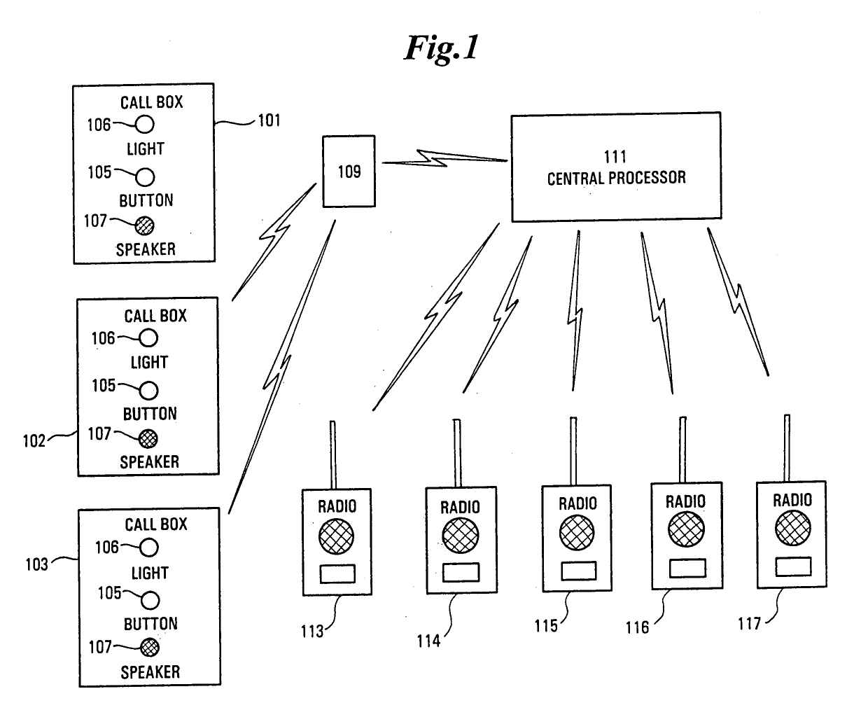

In FIG. 1, three call boxes 101-103 are shown. The call boxes 101-103 may be used to transmit calls for assistance to the central processor 111. Each call box includes a push button 105. The push button is accessible from outside the call box and a user may use the push button 105 to transmit a call for assistance. It is noted that fewer or more call boxes than the three shown in FIG. 1 may be used.

The call boxes 101-103 further include a light indicator 106 each. Many different well-known light indicators may be used with embodiments of the invention. For example, the light indicator 106 may be a LED. When the user transmits a call for assistance by using the actuator 105, the light indicator 106 is energized by the call box to indicate that the call for assistance is being transmitted. The call boxes 101-103 further include a speaker 107, for providing a voice message from the call box to the user. Many different voice messages may be used with embodiments of the invention. For example, the voice message may include an instruction for the user to remain at the location of the particular call box where the call for assistance was made.

When a user makes a call for assistance using the push button 105, the call for assistance is transmitted to the central processor 111. One or more repeaters 109 may be used to repeat the calls for assistance. Many different well-known repeaters may be used with embodiments of the invention. For example, the 900 MHz repeater manufactured by Inovonics Corporation under the product name FA525 may be used with embodiments of the invention. The repeater 109 may allow the calls for assistance to be retransmitted when, for example, the call boxes 101-103 are located far from the central processor 111. Also, the repeater 109 may facilitate retransmission of the calls for assistance when structural features such as walls, etc. would otherwise obstruct the transmission of the calls for assistance.

The central processor 111 receives the call for assistance and identifies which one of the call boxes 101-103 transmitted the call for assistance. The central processor 111 compiles a suitable paging message based on the received call for assistance. The paging message may, for example, include information on the location of the one of the call boxes 101-103 where the call for assistance was made. The central processor 111 will transmit the paging message to the portable radios 113-117. Associates which carry the portable radios 113-117, will receive the paging message from the central processor 111, and may report to the location of the call box, and assist the user. The portable radios 113-117 are two-way radio transceivers which are capable of transmitting and receiving radio signals including, for example, voice communication and receiving the paging messages from the central processor 111.

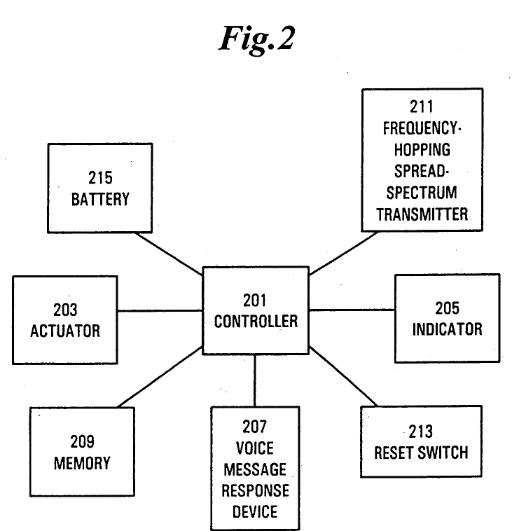

The call boxes 101-103 will now be further described with reference also to FIG. 2. An exemplary call box is shown schematically in FIG. 2. The call box is operated by a controller 201. Many well-known controllers may be used with embodiments of the invention. The controller 201 includes logic and may carry out algorithms suitable for the particular application.

A user may make a call for assistance using the actuator 203. Many different actuators may be used with embodiments of the invention. For example, the actuator 203 may include the push button 105 accessible from outside the call box. The actuator 203 transmits a signal to the controller 201 indicating that a user is making a call for assistance. The controller 201 actuates the frequency hopping spread spectrum transmitter 211, which transmits the call for assistance. It is noted that the transmitter 211 includes all components necessary for transmitting, such as an antenna, etc. Different well-known frequency hopping spread spectrum transmitters may be used with embodiments of the invention. For example, 900 MHz transmitters manufactured by Inovonics Corporation under the product names FA210 and FA211 may be used.

The controller 201 actuates the indicator 205, which for example may include the light indicator 106, to provide an indication to the user that the call for assistance has been transmitted.

The controller 201 also actuates the voice message response device 207 to provide a voice message to the user in response to the call for assistance made by the user. The controller 201 obtains the voice message, for example from the memory 209. Many different well-known memories may be used with embodiments of the invention. The memory 209 is capable of storing at least one recorded voice message that may be output to the user through the voice message response device 207. The memory 209 may, for example, be a chip memory, in which a voice message can be recorded as is conventionally known.

When an associate reports to the location of the call box where the call for assistance was made, the associate may reset the call box using the reset switch 213. Different well-known reset switches may be used with embodiments of the invention. After the reset switch 213 is actuated, a new call for assistance may be made from the call box in accordance with the above. If a new call for assistance is made at the call box after the first call for assistance was made, but before the call box has been reset, the controller 201 may, for example, proceed as follows: the indicator 205 is actuated, the voice message response device 207 again transmits the voice message to the user, but the transmitter 211 does not transmit a new call for assistance. It is noted that in other embodiments the controller 201 may carry out other steps, or no steps, in response to a call for assistance made before the call box is reset.

The call box is powered by the battery 215. Many well-known batteries may be used. For example, the battery 215 may be adapted to cause the controller 201 to transmit a low battery alert when the battery 215 runs low. The low battery alert may be transmitted through the transmitter 211, and received by the central processor 111, where the situation may be detected by an operator.

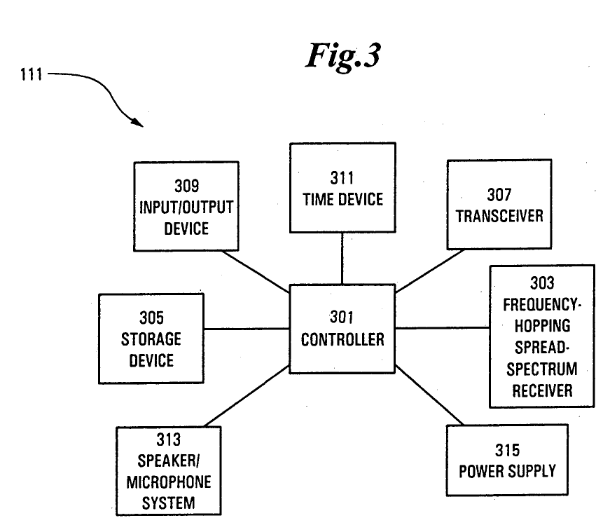

The central processor 111 will now be further described with reference also to FIG. 3. The central processor 111 includes a controller 301. The controller 301 includes logic and can carry out algorithms suitable for the application. The controller 301 is connected to a frequency hopping spread spectrum receiver 303 for receiving the calls for assistance from call boxes that are present in the system. It is noted that the receiver 303 includes all components necessary for receiving, such as an antenna, etc.

When a call for assistance is received by the receiver 303, the controller 301 accesses the storage device 305 in order to compile a paging message. Many different well-known storage devices may be used with embodiments of the invention. The storage device 305 is capable of storing a number of voice recordings, such that each voice recording is individually accessible by the controller 301. The storage device 305 is also capable of storing a log of events, such as calls for assistance. For example, the storage device 305 may store a start time, finish time, department location and/or other data regarding each particular call for assistance. It is noted that the storage device may consist of one or more units. For example, the storage device 305 may consist of a memory for storing a log, and chips for storing voice messages.

When the controller 301 receives a call for assistance through the transmitter 303, it determines which call box transmitted the call for assistance. Depending on the information in the call for assistance, the controller 301 accesses the storage device 305 to obtain the suitable voice recordings. The controller 301 will compile a paging message from one or more voice recordings in the storage device 305, and transmit the paging message through the transceiver 307. For example, voice recordings such as “nine”, “aisle”, and “guest assistance needed in” may be compiled by the controller 301 to provide the paging message “guest assistance needed in aisle 9”. The paging messages are transmitted by the transceiver 307 to be received, for example, by the portable radios 113-117 that may be carried by associates.

Different well-known transceivers may be used with embodiments of the invention. The transceiver is capable of transmitting and receiving signals to and from the portable radios 113-117. It is noted that the transceiver 307 includes all components necessary for transmitting and receiving, such as antennas, etc. The transceiver 307 may initially verify that a channel is clear prior to transmitting the paging message, by using a receiver function.

When the call for assistance is received at the central processor 111, the time device 311 registers a start time. When the call box from which the call for assistance was transmitted is reset, the time device 311 registers a finish time. The start time and the finish time may be stored for later evaluation. The start and finish times may, for example, be stored in the storage device 305.

The input/output device 309 may be used to output diagnostic information regarding the central processor 111. The input/output device 309 may, as another example, be used to input information to the central processor 111. For example, programming steps may be added, changed or deleted in the central processor 111. Furthermore, voice recordings may be brought to the central processor 111 through the input/output device 309.

Well-known input/output devices may be used with embodiments of the invention. For example, the input/output device 309 may include a modem and/or telephone line. When the input/output device 309 is used, information stored regarding the start and finish time of one or more calls for assistance may be output to an operator of the system. The stored log of start and finish times may for example be evaluated to determine the rate at which assistance arrives after a call for assistance is made.

The central processor 111 may periodically monitor the call boxes to verify that they still are in operation. For example, the call boxes may periodically transmit a supervisory central message to the central processor 111. If the call box does not transmit its supervisory control message within the expected time period, the central processor 111 will register that the call box is not operating. The central processor 111 may, for example, output the information regarding the call box through the input/output device 309, whereby an operator may notice the situation.

The central processor 111 may further include a speaker/microphone system 313, connected to the controller 301. The speaker/microphone system 313 may for example be used to record paging messages in the central processor 111. The operator recording the messages may read the messages into the microphone for recording. The speaker may be used for listening to recorded messages. Many different microphones and speakers may be used in the speaker/microphone system 313. For example, a conventional speaker and a conventional microphone may be used.

The central processor 111 further includes a power supply 315. Many different power supplies may be used with embodiments of the invention. For example, the power supply 315 may be a battery or a connection to a power outlet. The power supply 315 may optionally be capable of providing backup power if the regular mode power distribution fails, as is conventionally known.

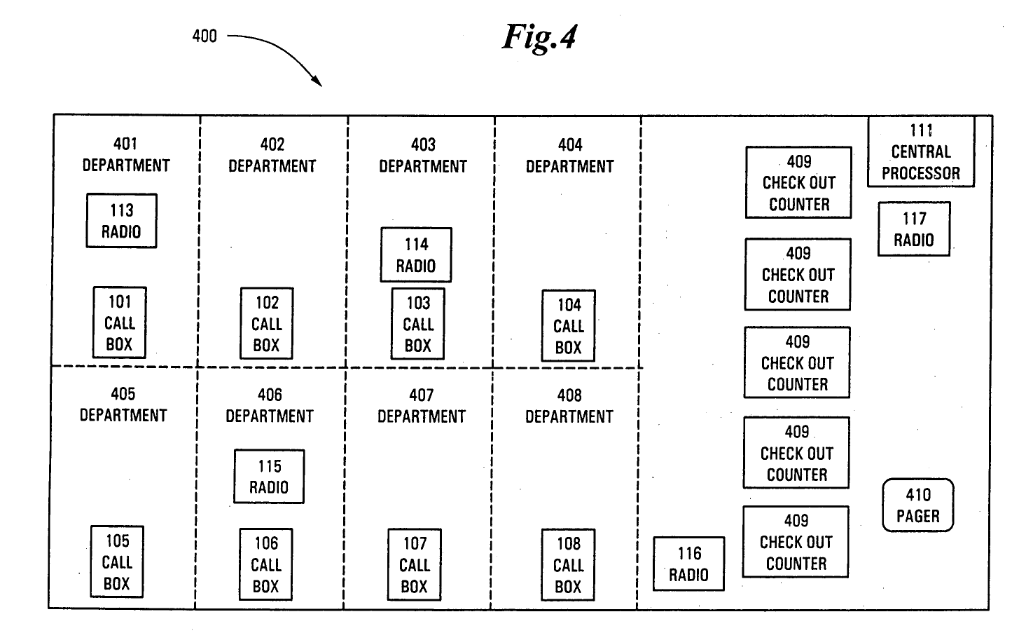

An exemplary use of the invention will now be described with reference also to FIG. 4. A floor plan of a retail business facility 400 is schematically shown. The retail business facility 400 includes departments 401-408, characterized for example by containing different categories of merchandise. Call boxes 101-108, substantially as described above, are located throughout the departments 401-408, such that each department has one call box. It is noted that other configurations of the departments and/or the call boxes are possible. The call boxes 101-108 are positioned at places where customers of the retail business facility 400 are likely to need assistance. The call boxes 101-108 are typically provided with information signs or labels indicating to the customers that the call box can be used to make a call for assistance. Associates of the retail business facility 400 are carrying the portable radios 113-117, which portable radios are illustrated at various locations in the facility 400.

The central processor 111 is schematically illustrated as a box mounted on a wall of the retail business facility 400. It is noted that the exact location of the central processor 111 may be chosen in consideration of the particular circumstances of the application. A number of check-out counters 409 are schematically illustrated toward one end of the retail business facility 400. It is noted that the call boxes 101-108 may be placed at suitable locations throughout the facility 400, for example including the area where the check-out counters 409 are located.

In this example, we assume that a call for assistance is made at the call box 104 in department 404. The call for assistance is transmitted from the call box 104 to the central processor 111. As noted above, a repeater (not shown) may repeat the call for assistance between the call box and the central processor. When the central processor 111 receives the call for assistance, it determines from which call box the call was made, and compiles a paging message, for example including the department number 404 or an equivalent name.

Upon transmitting the call for assistance, the call box 104 may, for example, energize a light indicator and provide a voice message to the customer who made the call for assistance. The voice message may include instructions to the customer, such as instructions to remain at the location of the call box 104.

The central processor 111 transmits the paging message to the portable radios 113-117. The associates of the facility 400 may hear the paging message through their respective portable radios. If an associate reports to the call box 104, he or she may reset the call box using the reset switch 213. If the call box has not been reset within a predetermined time, the central processor 111 may take further steps. For example, the central processor 111 may transmit a message to a pager 410. Many different well-known pagers may be used with embodiments of the invention. For example, a conventional pager may be used, whereby the central processor 111 may transmit a regular paging phone call to reach the pager 410. A manager or equivalent may wear the pager 410 to be informed when a call for assistance has not been reset within the predetermined time. Also, the call box may be automatically reset if it has not been manually reset within a time limit.

System Summary

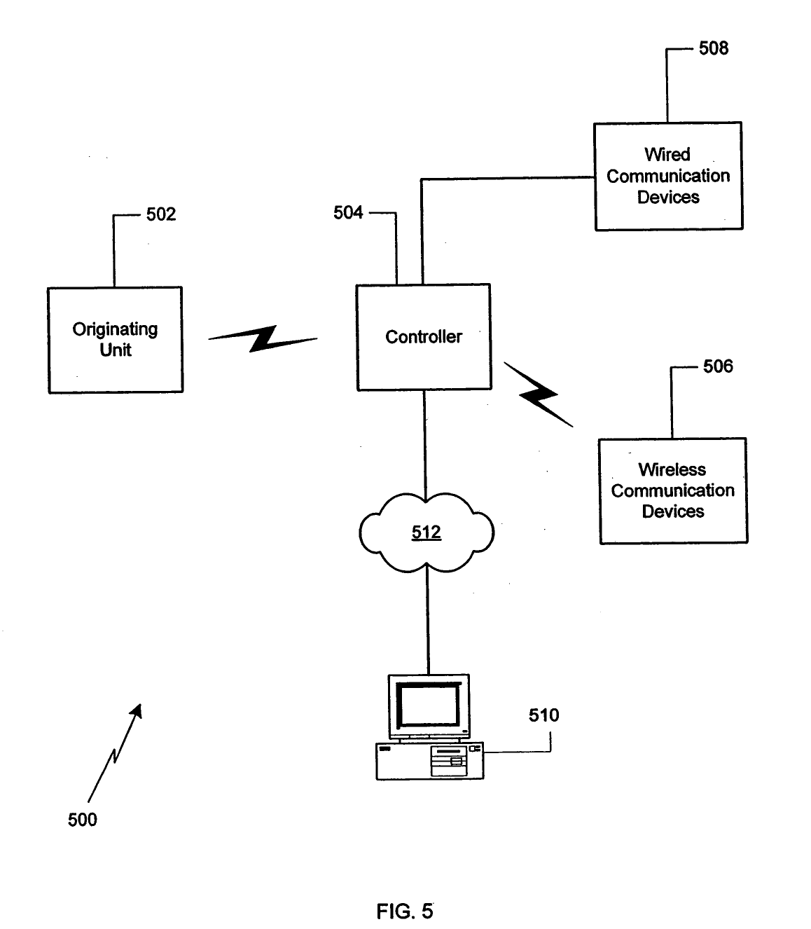

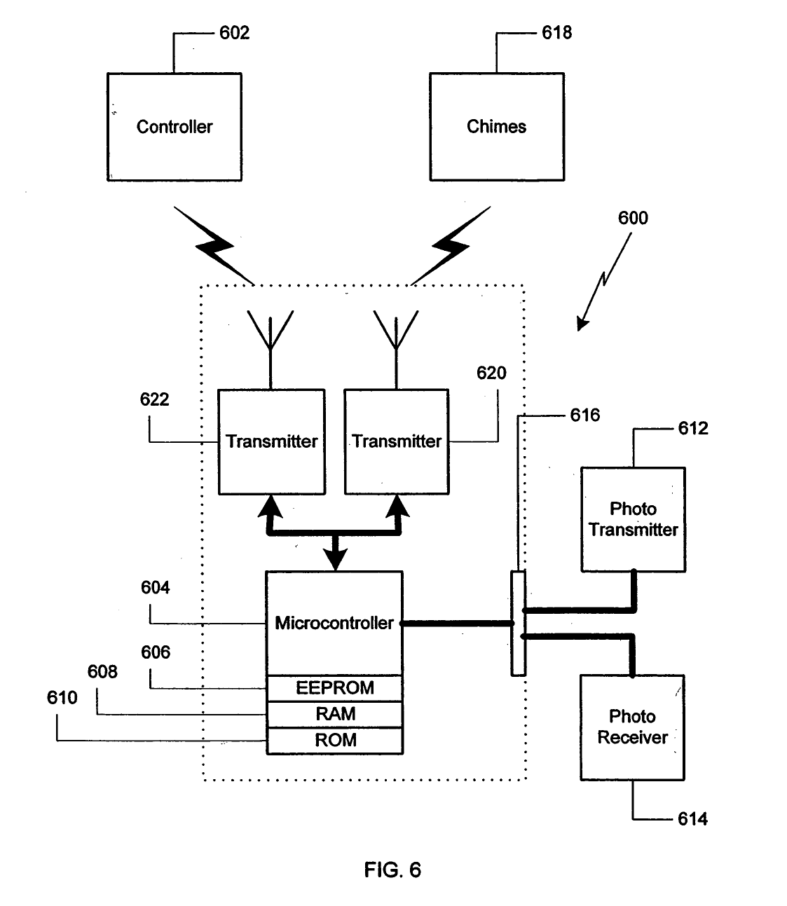

FIG. 5 depicts a system that may embody the technology previously presented with reference to FIGS. 1-4, and may also embody other technology discussed with reference to FIGS. 6-14. As can be seen from FIG. 5, a wireless communication system 500 includes an originating unit 502 that communicates via wireless transmission with a controller 504. For example, the originating unit 502 may be a call box as described with reference to FIGS. 1-4. Alternatively, the originating unit 502 may be a people counter, of the variety typically used in commercial settings to count the volume of customers passing by a particular point in a store. Still further, the originating unit 502 may be a smoke detector, heat detector, or flame detector. In principle, the originating unit 502 may be any device that detects the occurrence of an event, and communicates the occurrence of the event to the controller 504.

The communication system 500 is depicted as including a single originating unit 502, for the sake of simplification. A typical wireless communication system 500 includes many originating units 502. For example, a typical wireless communication system 500 may include a plurality of call boxes located at various points in a store, a plurality of people counters also located at various points around the store, and flame and smoke detectors located in a public restroom area. Each of those originating units 502 communicates the occurrence of an event to the controller 504.

In response to having received a communication from an originating unit 502, the controller 504 may log the occurrence of the even in a memory device, and may communicate a message to an appropriate destination device, which may be either a wired destination device 506, or a wireless destination device 508. Wired destination devices 506 may include a public address system or a telephone, for example. Wireless destination devices 508 may include two-way radios, and pagers, for example. Thus, the wireless communication system 500 may function generally as follows. A customer may push a call button on a call box (i.e., originating unit 502). The call box transmits a message to the controller 504 indicating that the call button has been selected. In response, the controller 504 logs the occurrence of the event in a memory device, and communicates the occurrence of the event to a pager (i.e., wireless destination device 508) worn by an employee assigned to assist customers. In response, the employee provides assistance to the customer.

The controller 504 may also communicate with a computer 510. Such communication may occur via a network 512, such as a local area network, or the Internet. For example, the computer 510 may request the controller 504 to generate reports based upon the logged events (e.g., number of call requests per department or plotted against time of day, etc.).

Communication between an originating unit 502 and the controller may take on the form of a message frame. For example, an originating unit may communicate a set of data including:
{unit id#, system id#, status data, checksum data}

The unit id# is a unit of information identifying the originating unit transmitting the message frame. The system id# is a unit of information identifying the wireless communication system of which the originating unit is a constituent. A system id# may be used to prevent an originating unit 502 within one wireless communication system from communicating with a controller 504 that is a part of another wireless communication system. For example, two juxtaposed stores may use wireless communication systems, meaning that a transmission from a call box located in one store may reach a controller in the juxtaposed store. The controller may discriminate received message frames on the basis of the system id# (i.e., all originating units intended to communicate with the controller have a particular system id#; all received message frames not including the particular system id# are ignored by the controller.) Turning attention to the status data, the status data indicates the reason for the message frame. For example, a data value indicating an “alarm state” means that the originating unit has observed the occurrence of an event (e.g., a call button on a call box was pushed, or a flame was detected by a flame detector, etc.). A data value indicating a “clear state” means that the originating unit no longer observes the sought-after event (e.g., a call button on a call box was released, or a flame is no longer detected by a flame detector). Other status data may include an indication of battery life of a particular originating unit, or an indication that the originating unit has been tampered with.

The transmission between an originating device 502 and a controller 504 may use a protocol to minimize interference that arises as a result of simultaneous transmissions by two originating units 502. An originating unit 502 may transmit a message frame to a controller 504 redundantly. For example, an originating unit 502 may transmit a message frame to a controller 24 times. Thus, unless all 24 transmissions are interfered with, communication between the originating unit 502 and the controller 504 is successful. Additionally, each of the transmissions may be separated by a randomly assigned span of time, thereby further reducing the likelihood of interference between two or more originating devices. Other techniques may be employed, as well. For example, the message frames may be transmitted via a spread spectrum technique (e.g., FHSS at 900 MHz).

People Counter

FIG. 6 depicts a people counter 600. The people counter 600 is a device that detects the presence of a person in a particular location. For example, people counters may be placed in many locations within a commercial setting to count the number of people passing by a location (e.g., a people counter may be placed by a door to count the number of people entering or exiting a store, or may be placed by a particular display to count the number of people approaching the particular display).

Typically, a people counter transmits a message frame to a controller (such as 602) whenever the presence of a person is detected. Accordingly, the controller 602 receives message frames from all of the people counters within the wireless communication system (e.g., the controller receives message frames from all of the people counters within a store), and maintains various statistics based thereupon. For example, the controller may calculate the total number of people passing through a doorway in a given day, or may calculate the total number of people passing through a doorway during specified intervals (e.g., total number of people passing through a doorway from 2:00 PM to 3:00 PM, or from 3:00 PM to 4:00 PM, etc.).

The aforementioned scheme exhibits certain drawbacks. For example, in a busy store having multiple people counters, there is an elevated risk of interference stemming from two or more people counters attempting to transmit simultaneously. Such interference may prevent the controller from counting a person that has been observed by a people detector. The people detector 600 of FIG. 6 addresses this drawback.

The people detector 600 includes a microcontroller or microprocessor 604 that is coupled to one or more memory devices, such as an EEPROM 606, RAM 608 and ROM 610. For example, the ROM 610 may be used to store firmware, the RAM 608 may be used to store working variables/registers, and the EEPROM 606 may be used to store programmable parameters. The microcontroller 604 and the memory devices 606-610 may be embodied as separate chips, or may be embodied as a single chip.

The microcontroller 604 communicates with a phototransmitter 612 and a photoreceiver 614. An I/O port 616 may be interposed between the microcontroller 604 and the phototransmitter 612 and photoreceiver 614. The phototransmitter 612 may emit electromagnetic radiation that is received by the photoreceiver 614. In response to incident electromagnetic radiation, the photoreceiver 614 exhibits a voltage on its output line. Thus, when the optical path between the phototransmitter 612 and the photoreceiver 614 is unobstructed, the output line of the photoreceiver 614 exhibits a high voltage. On the other hand, if the path between the phototransmitter 612 and the photoreceiver 614 is obstructed, the output line of the photoreceiver 614 exhibits a low voltage, because no electromagnetic radiation is incident upon the photoreceiver, and its output line is not excited. The combination of the phototransmitter 612 and photoreceiver 614 thus indicate the presence of a person by virtue of indicating the presence of an obstruction in the optical path from the phototransmitter 612 to the photoreceiver 614.

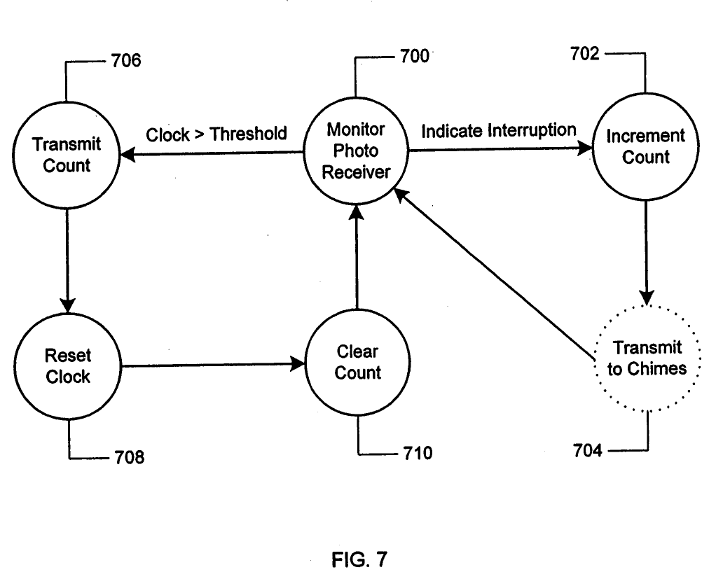

The microcontroller 604 monitors the I/O port 616 to observe the voltage exhibited by the photoreceiver 614, thereby detecting the presence of a person. This action is depicted as state 700 in FIG. 7. An interruption of the optical path between the phototransmitter 612 and the photoreceiver 614 is indicated by a transition from a high voltage to a low voltage (or vice versa) on the output line of the photoreceiver 614. When an interruption of the optical path is detected, the microcontroller 604 increments a count variable, as shown in state 702. The count variable is used to keep track of the number of people detected by the people detector 600.

Next, the system may optionally emit a transmission to a chimes unit 618, as shown in state 704. The transmission is caused by a command from the microcontroller 604 to a transmitter 620. In response to reception of the transmission, the chimes unit 618 emits a chime, such as a tone, a song, a bell, etc. The particular chime emitted by the chimes unit 618 may be programmable. For example, a data value within the message frame transmitted to the chimes unit 618 may be used to select from amongst a set of chimes options. After transmission to the chimes unit 618, the people counter 600 returns to the monitor photoreceiver state 700.

The microcontroller 604 is programmed to keep track of a clock variable, which indicates the passage of time. When the clock variable exceeds a certain value (e.g., 5 minutes or 20 minutes), the people counter 600 transitions to a transmit count state 706. In state 706, the microcontroller commands the transmitter 622 to transmit a message frame to the controller 602. The message frame contains the count variable mentioned with reference to state 702. Thus, the people counter 600 transmits the count total to the controller on a periodic basis, and maintains a running total in the periods between transmissions. This has the effect of minimizing the probability of interference stemming from two or more people counters attempting to transmit simultaneously. After transmission of the count variable, the people counter 600 transitions to reset clock state 708, in which the aforementioned clock variable is reset. Thereafter, the people counter transitions to clear count variable state 710, in which the count variable described with reference to state 702 is reset to zero. Finally, the people counter 700 returns to monitor photoreceiver state 700.

Optionally, prior to execution of the transmission operations in state 706, the microcontroller may divide the count variable by a programmable value. For example, the intent of the people counter 600 may be to count the number of people entering a store. Therefore, the people counter 600 may be located by a door that provides entry to the store. However, since everyone who enters the store also exits the store, the count variable may be inflated by a factor of two. Hence, in that scenario, the microcontroller 604 may be programmed to divide the count variable by a denominator of two prior to transmission. In other scenarios, other denominators may be desirable, and the microcontroller 604 may be programmed to divide the count variable by any value.

Parallel/Serial Remote Transmission Unit

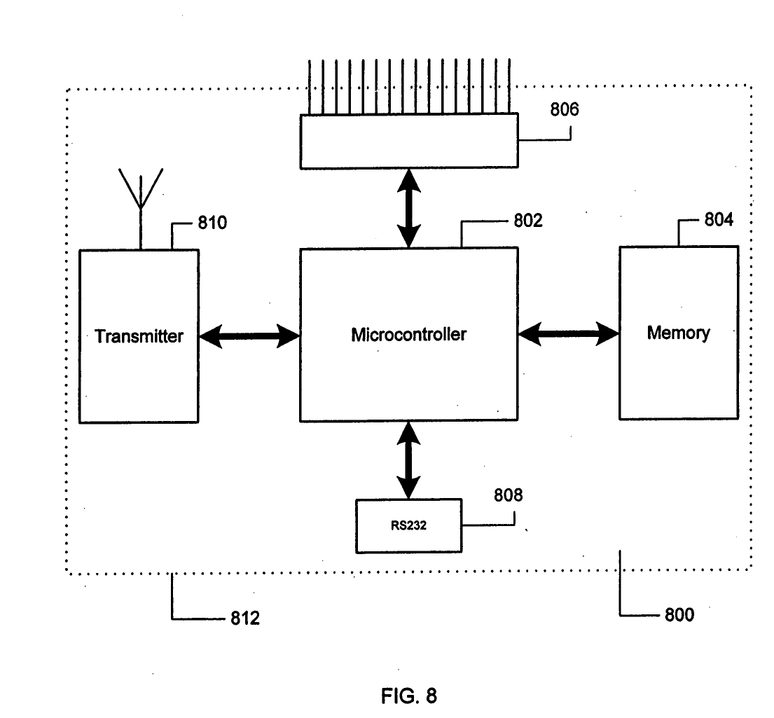

FIG. 8 depicts a remote terminal unit 800. The remote terminal unit 800 is a device that connects many originating units 502 to a single transmitter. Thus, for example, 16 call boxes may be connected (by a wired connection) to the remote terminal unit 800. When any one of the 16 call boxes detects a pushed call button event, the remote terminal unit commands the transmitter to send an appropriate message frame declaring the event. The net result is that the remote terminal unit functions similar to a multiplexer, mediating communication between many originating units 502 and one transmitter. The benefit of such an arrangement is a cost savings, owed to elimination of the need to have an equal number of transmitters and originating units 502.

As can be seen from FIG. 8, the remote terminal unit 800 includes a microcontroller 802 that is coupled to a memory device 804. The memory device 804 may consist of a RAM, a ROM, and an EEPROM. For example, the ROM may be used to store firmware, the RAM may be used to store working variables/registers, and the EEPROM may be used to store programmable parameters. The microcontroller 802 and the memory device(s) 804 may be embodied as separate chips, or may be embodied as a single chip.

The microcontroller 802 communicates with originating devices via input/output (I/O) ports, such as parallel I/O port 806 and serial I/O port 808 (which may be an RS-232 serial port). The microcontroller 802 is in data communication with a transmitter 810. The microcontroller 802, memory device 804, parallel I/O port 806, serial port 808, and transmitter 810 may be contained within a single housing 812.

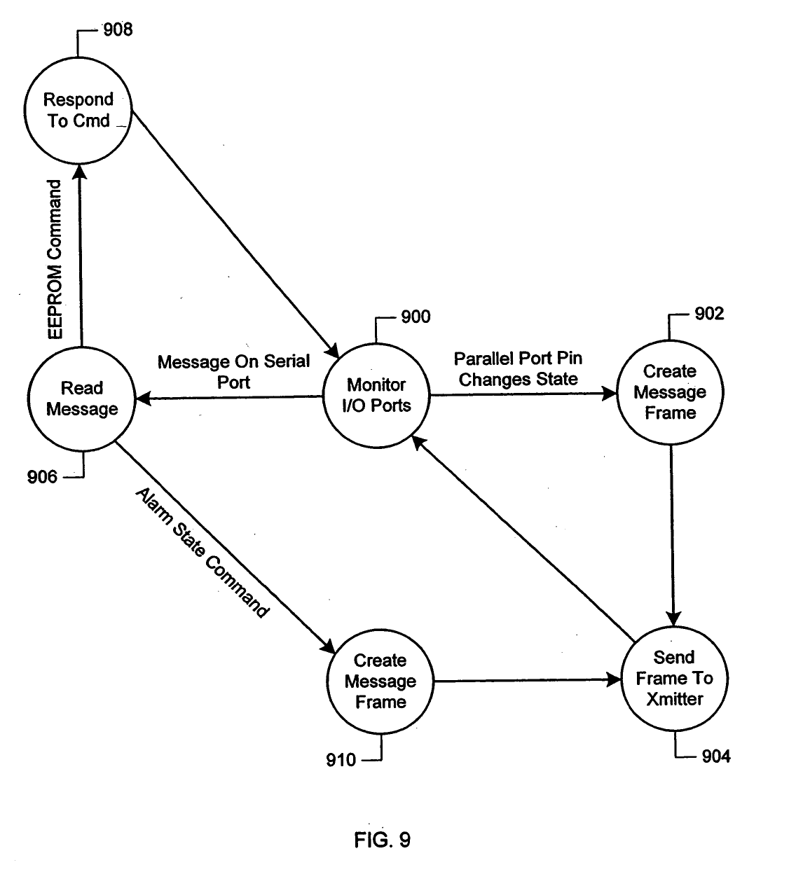

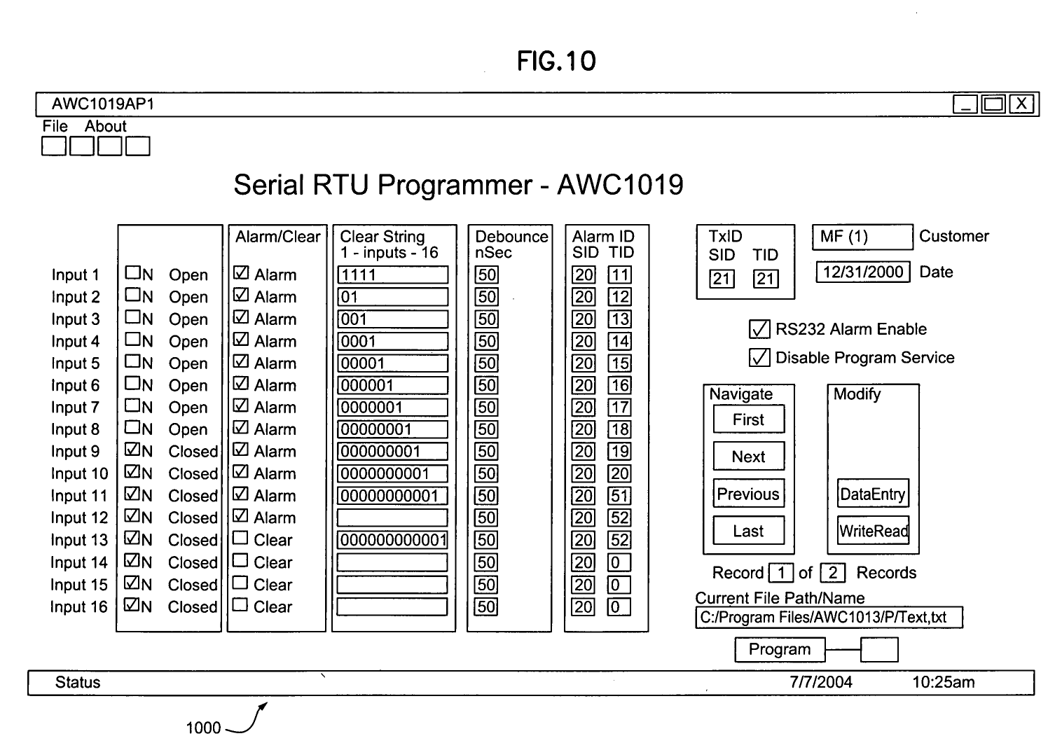

The microcontroller 802 monitors the I/O ports 806 and 808, as indicated in FIG. 9, with reference to state 900. When a pin in the parallel port 806 changes state (e.g., transitions from a low voltage to a high voltage or vice versa), the microcontroller 802 creates an appropriate message frame (state 902) that is ultimately transmitted to a controller 504. For example, the microcontroller 802 may access a table stored in the memory device 804, in order to determine the system id#, unit id#, and status data to enter into the message frame. Per such a design scenario, the table associates a particular pin in the parallel I/O port 806 with a system id# and a unit id#. Also, the microcontroller 802 may access a table to determine whether the change of state indicates an alarm condition (event detected) or a clear condition (event no longer detected). Per such a design scenario, the table associates a particular pin in the parallel I/O port 806 with a normally low or normally high state. Thus, a departure from the indicated normal state corresponds to an alarm condition, and a return to the indicated normal state corresponds to a clear condition. The table may be constructed based on user input entered into a user interface depicted as FIG. 10, discussed in greater detail, below. After creation of the of the message frame, the message frame is sent to the transmitter 810, as indicated in state 904, and is transmitted to the controller 504. Thereafter, the microcontroller 802 returns to the monitor I/O ports state 900.

Reception of a data message via the serial I/O port 808 may also cause an exit from the monitor I/O ports state 900. Upon reception of a data message via the serial I/O port 808, the microcontroller reads the data message, as indicated by state 906, in order to determine the step to next take. The data message received via the serial I/O port 808 may include:
{op code, data address, data, system id#, transmit id#, alarm state}

The op code indicates whether the purpose of the data message. The op code may indicate that data is to be read from the memory device 804, that data is to be written to the memory device 804, that the memory device 804 is to be erased, or that the message indicates alarm/clear status of a device coupled to the serial I/O port 808. The data address indicates the address range to be read from or written to. The data field contains the data to be written to the memory device 804. The system id# has already been discussed. The transmit id# is akin to a unit id#, and is discussed in greater detail below. The alarm state indicates whether the device coupled to the serial port is communicating an alarm state or a clear state.

If the data message indicates that the memory device 804 is to be read from, written to, or erased, then the microcontroller 802 transitions to state 908, whereupon the microcontroller responds to the command. Responding to the command includes reading from, writing to, or erasing the memory device 804, as commanded. It may also include generating a response message for communication to the device coupled to the serial I/O port 808. The response message may be structured as a mirror image of the command data message, with the inclusion of a positive acknowledgement bit, that informs the device coupled to the serial I/O port 808 that the message has been correctly received and acted upon. Of course, if the command data message instructed the microcontroller 802 to read from a particular address range, the response message contains the data that was read. Thereafter, the microcontroller 802 returns to the monitor I/O ports state 900.

If the data message indicates that the message indicates alarm/clear status of a device coupled to the serial I/O port 808, then the microcontroller 802 transitions to state 910, whereupon the microcontroller 802 creates an appropriate message from the data contained in the data message. Thereafter, the message frame is communicated to the transmitter (state 904), and the microcontroller 802 returns to the monitor I/O ports state 900.

FIG. 10 depicts a user interface 1000 that may be used to create the aforementioned tables from which system id#, unit id#, and status data is generated for creation of the message frame in response to a pin in the parallel I/O port changing state. As can be seen from FIG. 10, the user interface 1000 is organized so that “input polarity,” “alarm/clear,” “clear string,” debounce,” and “alarm id” may be entered for each pin in the parallel I/O port 806. (“Input 1” refers to the first pin in the parallel I/O port 806, “input 2” refers to the second pin in the parallel I/O port 806, and so on). A user may select the “input polarity” check box to indicate that a particular is normally closed, and that the input should therefore normally appear grounded.

A user may select the “alarm/clear” check box to indicate whether a message frame indicating an alarm status should be sent to the transmitter 800 when a particular pin deviates from its normally indicated state.

A user may enter a “clear string” in order to identify which pins (and therefore unit ids#) should be cleared when a particular pin transitions back to its normally indicated state. For example, as depicted in FIG. 10, the first pin in the parallel port is assigned a clear string reading “1111,” meaning that pins 1, 2, 3, and 4 should be cleared when that pin transitions to its normally indicated state. Therefore, upon a return to the normally indicated state, four message frames should be sent to the transmitter—a first message frame indicating a clear status for the unit id# associated with the first pin, a second message frame indicating a clear status for the unit id# associated with the first pin, and so on.

A user may enter a “debounce” value in order to reduce the likelihood of sending false alarm states resulting from a “bouncing” switch. The debounce value indicates a period of time (e.g., 50 msec) that must elapse after a first observation of an apparent change of state of a pin in the parallel I/O port 806. After the debounce period has elapsed, the pin is double-checked to see if it is still in the new state. If so, then the pin is determined to have changed state. If not, the apparent change of state is ignored.

Finally, an “alarm/id” field permits a user to enter a system id# and unit id# to be associated with each pin in the parallel I/O port 806.

Data Concentrator

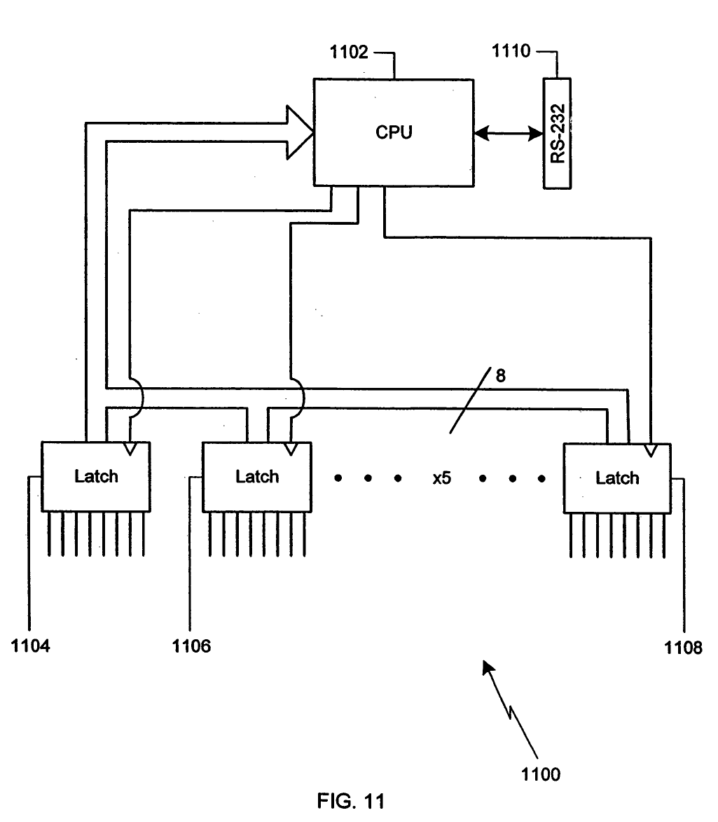

FIG. 11 depicts a data concentrator 1100. The data concentrator 1100 may be connected to the serial I/O port 808 of the remote terminal unit 800, so that a great many originating devices (e.g., 64 devices) may share a single transmitter 810. The data concentrator 1100 includes a microcontroller 1102 coupled to a memory device (not depicted). The microcontroller 1102 is coupled to eight latches 1104-1108, three of which are shown in FIG. 11. As mentioned earlier, the microcontroller 1102 communicates with the remote terminal unit 800 via a serial port 1110.

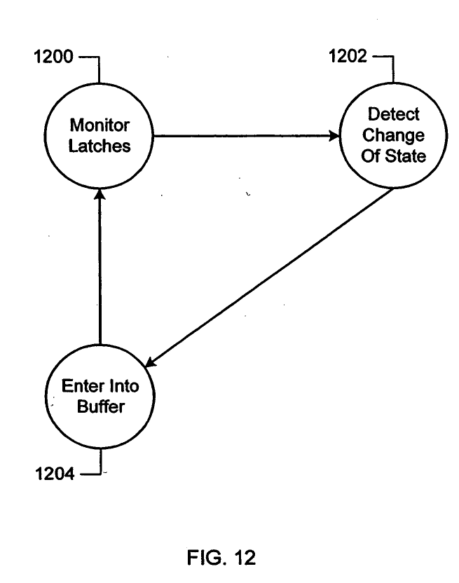

The data concentrator 1110 may have an originating unit coupled to each pin in each of its latches 1104-1108. The data concentrator 1100 monitors each pin for a change of state, and creates a data message (of the structure described above) upon observation of the change of state. The data message is then communicated to the remote terminal unit 800 via the serial port 1110. The remote terminal unit 800 then transmits a message frame to the controller 504, indicating the change of state of the particular originating unit coupled to the pin on which a change of state has been detected. This general functionality is described by a state transition diagram depicted in FIG. 12. As can be seen from FIG. 12, the microcontroller 1102 is in a monitor latch mode 1200, until it perceives a potential change of state, whereupon it transitions to a detect change of state mode 1202. The details of state 1202 are described below. If a change of state is detected, a data message indicating the change of state is entered into a buffer (as shown in operation 1204) for communication to the remote terminal unit 800 via the serial port 1110. Thereafter, the microcontroller returns to monitoring the latches for a perceived change of state, as shown in state 1200.

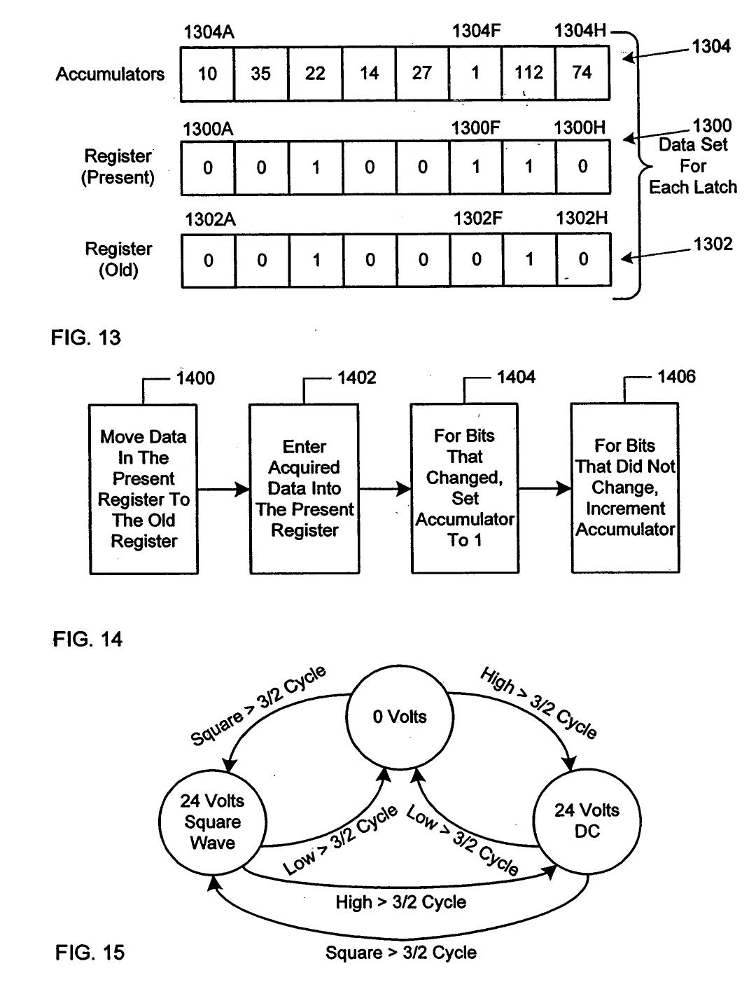

FIGS. 13-15 jointly depict a scheme by which the data concentrator 1100 may determine if a change of state occurs on any one of the input pins of any one of the latches 1104-1108.

FIG. 13 depicts a pair of registers 1300 and 1302 and an accumulator 1304. The registers 1300 and 1302 and accumulator 1304 may be stored in a memory unit coupled to the CPU 1102, or may be embodied as registers located on the CPU chip 1102, itself. The first register 1300 is assigned to the first latch 1104, and includes eight data locations 1300A-H, one data location 1300-A-H for each input pin of the first latch 1104. Data location 1300A is associated with the first pin of the first latch 1104, data location 1300B is associated with the second pin of the first latch 1104, and so on. Although not depicted, there exists one such register 1300 for each latch 1104-1108.

Microprocessor 1102 (FIG. 11) may periodically poll each of the latches 1104-1108, to determine whether the input pins of the poled latch 1104-1108 exhibit a high or low voltage. For example, the microprocessor 1102 may poll each latch 1104-1108, on a latch-by-latch basis, polling each latch for a millisecond, before polling the next latch. Per such a scenario, each latch is polled once every eight milliseconds. Thus, the microprocessor 1102 is provided with information, regarding whether any given pin exhibits a high or low voltage once every eight milliseconds.

Each data location 1300A-H in the first register 1300 contains a “1” or a “0,” indicating whether the particular pin associated with a particular data location 1300A-H exhibited a high or low voltage the last time the latch 1104-1108 was polled by the microprocessor 1102. Thus, since data location 1300A is depicted as containing a “0,” this means that the first pin on the first latch 1104 exhibited a low voltage at the last time the latch 1104 was polled. On the other hand, since data location 1300F contains a “1,” the sixth pin on the first latch 1104 exhibited a high voltage at the last time the latch 1104 was poled.

As shown in FIG. 14, the microprocessor 1102 of the data concentrator 1100 begins the process of identifying a change of state of a given pin (operation 1202 of FIG. 12) by moving data from the first register 1300 into the second register 1302 (operation 1400). The purpose for this data manipulation is discussed below. Thereafter, a particular latch 1104-1108 is polled, and the data determined therefrom is entered into the first register 1300, as shown in operation 1402.

As a consequence of the steps 1400 and 1402, first and second registers 1300 and 1302 contain data regarding whether the various pins of the first latch 1104 were high or low during the last time the latch 1104 was polled (register 1300) and during the time of polling prior to that (register 1302). By comparing register 1300 to register 1302, it can be determined whether a voltage transition has been exhibited on a particular pin. For example, register 1302 reveals that during the previous polling period, the sixth pin of the first latch 1104 has exhibited a low voltage, while register 1300 reveals that during the most recent polling period, the sixth pin of the first latch 1104 has exhibited a high voltage, meaning that a voltage transition was exhibited on the sixth pin.

The accumulator 1304 includes eight data locations 1304A-H, each data location being associated with a given pin of a given latch. Thus, for example, data location 1304A is associated with the first pin of the first latch 1104, while data location 1304F is associated with the sixth pin of the first latch 1104. Although not depicted, there exists one such accumulator 1304 for each latch 1104-1108.

As shown in step 1404, the microprocessor 1102 examines registers 1300 and 1302, to determine which pins have exhibited a voltage transition during the last polling period. The data location associated with each pin exhibiting a voltage transition is reset to a value of one. Thus, for example, data location 1304F contains a value of one, because registers 1300 and 1302 reveal that the sixth pin of the first latch 1104 exhibited a voltage transition during the last polling period. On the other hand, as shown in operation 1406, the data locations associated with each pin exhibiting a voltage transition are incremented. Thus, the net result of operations 1400-1406 is that a running count is kept in accumulator 1304 of how long a given pin on a given location has exhibited a given voltage.

Using the data in accumulator 1304, the state transition diagram of FIG. 15 may be carried out. The state transition diagram of FIG. 15 allows for the input pins of the latches 1104-1108 to exhibit three states: (1) a high state; (2) a low state; and (3) a square wave state (the voltage alternates between high and low voltages at a known period). As shown by state transition diagram 15, when a given input pin exhibits a voltage transition, the decision regarding what state the pin is exhibiting is delayed for a period of time greater than 1.5 periods of a square wave constituting the square wave state. After the aforementioned period has elapsed, it is determined whether the particular pin returned to its previous voltage (i.e., whether it exhibited another voltage transition), and if so, whether the particular pin is changing states in a pattern consistent with being in a square wave state. If the particular pin exhibits a square wave for more a period of time greater then 1.5 periods of the square wave, it is determined that the particular pin is in the square wave state. Otherwise, it is determined that the particular pin is in the state identified by the voltage transition.

Although the invention has been described with respect to preferred embodiments thereof, it is to be understood that it is not so limited since changes and modifications can be made therein which are within the full intended scope of this invention as defined by the broad general meaning of the wording in the appended claims.

1. A device for transmitting a signal indicating an occurrence of an event to a remotely located receiver, the device comprising:
an event detector;
a microprocessor in data communication with the event detector;
a memory device coupled to the microprocessor; and
a first transmitter coupled to the microprocessor;
wherein, the memory device stores a set of instructions that cause the microprocessor to cooperate with the event detector, the first transmitter, and the memory device to carry out the following acts
monitoring the event detector for an indication of an occurrence of an event;
incrementing a count variable if an occurrence of an event is indicated by the event indicator; and
transmitting the count variable to the remotely located receiver, when a clock value exceeds a threshold.

2. The device of claim 1, wherein the memory stores a set of instructions that causes the microprocessor to cooperate with the event detector, the first transmitter, and the memory device to carry out the following additional acts:
resetting the clock value after transmission of the count variable; and
resetting the count variable after its transmission.

3. The device of claim 1, wherein the count variable is transmitted within a message frame.

4. The device of claim 3, wherein the message frame includes a value identifying the device transmitting the count variable.

5. The device of claim 4, wherein the message frame includes a value identifying a system of which the device transmitting the count variable is a component.

6. The device of claim 3, wherein the act of transmitting the count variable comprises transmitting a plurality of message frame.

7. The device of claim 6, wherein random durations of time separate each of the plurality of message frames.

8. The device of claim 1, wherein the event detector comprises a presence sensor.

9. The device of claim 8, wherein the presence sensor comprises a phototransmitter and a photoreceiver.

10. The device of claim 1, wherein the memory stores a set of instructions that causes the microprocessor to cooperate with the event detector, the first transmitter, and the memory device to carry out the following additional acts:
divide the count value by a denominator.

11. The device of claim 10, wherein the denominator is two.

12. The device of claim 1, further comprising a first transmitter coupled to the microprocessor, and wherein the memory stores a set of instructions that causes the microprocessor to cooperate with the event detector, the first transmitter, and the memory device to carry out the following additional acts:
transmit a signal to a second remote receiver unit with each occurrence of an event.

13. The device of claim 12, wherein the second remote receiver unit comprises a chiming apparatus.

14. A method of transmitting a signal indicating an occurrence of an event to a remotely located receiver, the method comprising:
monitoring an event detector for an indication of an occurrence of an event;
incrementing a count variable if an occurrence of an event is indicated by the event indicator; and
transmitting the count variable to the remotely located receiver, when a clock value exceeds a threshold.

15. The method of claim 14, further comprising:
resetting the clock value after transmission of the count variable; and
resetting the count variable after its transmission.

16. The method of claim 14, wherein the count variable is transmitted within a message frame.

17. The method of claim 16, wherein the message frame includes a value identifying the device transmitting the count variable.

18. The method of claim 17, wherein the message frame includes a value identifying a system of which the device transmitting the count variable is a component.

19. The method of claim 16, wherein the act of transmitting the count variable comprises transmitting a plurality of message frames.

20. The method of claim 19, wherein random durations of time separate each of the plurality of message frames.

21. The method of claim 14, further comprising:
dividing the count value by a denominator.

22. The method of claim 21, wherein the denominator is two.

23. A remote terminal unit for transmitting a signal indicating an occurrence of an event to a remotely located receiver, the unit comprising:
a microprocessor coupled a parallel input/output (I/O) port and to a serial I/O port;
a memory unit coupled to the microprocessor; and
a transmitter in data communication with the microprocessor;
wherein the memory device stores a set of instructions that cause the microprocessor to cooperate with the transmitter, the serial I/O port, the parallel I/O port, and the memory device to carry out the following acts
monitor the parallel and serial I/O ports;
create a message frame in response to a pin within the parallel I/O port changing state;
create a message frame in response to a data message received via the serial I/O port;
communicate the message frame to the transmitter for transmission to the remotely located receiver;
wherein the message frame includes a value identifying a device coupled to the pin that changed state within the parallel I/O port or identifying an alarm condition associated with a computer coupled to the serial I/O port.

24. The remote terminal unit of claim 23, wherein the memory device stores a set of instructions that cause the microprocessor to cooperate with the transmitter, the serial I/O port, the parallel I/O port, and the memory device to further carry out the following acts
reading from a memory address in response to a data message received via the serial I/O port commanding such an action; and
writing to a memory address in response to a data message received via the serial I/O port commanding such an action.

25. The remote terminal unit of claim 23, wherein the message frame further includes a value identifying a system of which the remote transmitting unit is a component.

26. A wireless communication system comprising:
the remote terminal unit of claim 23; and
a plurality of devices, each of which generates a signal on an output line, the signal indicating occurrence of an event, the output line of each device being coupled to one of a plurality of pins within the parallel I/O port within the remote terminal unit.

27. The wireless communication system of claim 26, wherein the at least one of the plurality of devices comprises a presence detector.

28. The wireless communication system of claim 26, wherein the at least one of the plurality of devices comprises a call box.

29. The wireless communication system of claim 26, wherein the at least one of the plurality of devices comprises a flame detector.

30. The wireless communication system of claim 26, wherein the at least one of the plurality of devices comprises a smoke detector.

31. The remote terminal unit of claim 23, wherein the memory device stores a set of instructions that cause the microprocessor to cooperate with the transmitter, the serial I/O port, the parallel I/O port, and the memory device to further carry out the following acts associating a first voltage on a first pin in the parallel I/O port with an alarm state; and
associating a second voltage on the first pin in the parallel I/O port with a clear state.

32. The remote terminal unit of claim 31, wherein the memory device stores a set of instructions that cause the microprocessor to cooperate with the transmitter, the serial I/O port, the parallel I/O port, and the memory device to further carry out the following acts
create a plurality of message frames in response to the first pin in the parallel I/O port transitioning to a clear state; and
communicate the plurality of message frames to the transmitter for transmission to the remotely located receiver.

33. The remote terminal unit of claim 32, wherein each of the plurality of message frames includes a value identifying a device coupled to one of a plurality of pins in the parallel I/O port.

34. A method of transmitting a signal indicating an occurrence of an event to a remotely located receiver, the method comprising:
monitoring parallel and serial I/O ports;
creating a first message frame in response to a pin within the parallel I/O port changing state;
creating a second message frame in response to a data message received via the serial I/O port;
communicating the message frame to a transmitter for transmission to the remotely located receiver;
wherein the first message frame includes a value identifying a device coupled to the pin that changed state within the parallel I/O port.

35. The method of claim 34, wherein:
the second message frame includes a value identifying an alarm condition associated with a computer coupled to the serial I/O port.

36. The method of claim 34, further comprising:
reading from a memory address in response to a data message received via the serial I/O port commanding such an action; and
writing to a memory address in response to a data message received via the serial I/O port commanding such an action.

37. The remote terminal unit of claim 36, wherein the first and second message frames further include a value identifying a system of which the remote transmitting unit is a component.

38. The method of claim 34, further comprising:
associating a first voltage on a first pin in the parallel I/O port with an alarm state; and
associating a second voltage on the first pin in the parallel I/O port with a clear state.

39. The method of claim 38, further comprising:
creating a plurality of message frames in response to the first pin in the parallel I/O port transitioning to a clear state; and
communicating the plurality of message frames to the transmitter for transmission to the remotely located receiver.

40. The method of claim 39, wherein each of the plurality of message frames includes a value identifying a device coupled to one of a plurality of pins in the parallel I/O port.

41. A data concentrator comprising:
a microprocessor in data communication with a plurality of latches;
a memory device coupled to the microprocessor;
a serial I/O port in data communication with the microprocessor;
wherein the memory device stores a set of instructions that cause the microprocessor to cooperate with the latches, the serial I/O port, and the memory device to carry out the following acts detecting a change of state on one of the pins within one of the plurality of latches;
entering a data message into a buffer, the data message including a value identifying a device coupled to the pin on which the change of state was detected;
communicating the data message via the serial I/O port.

42. A wireless communication system comprising:
the data concentrator of claim 41; and
a remote terminal unit having a serial port and a transmitter;
wherein the serial I/O port of the data concentrator is in data communication with the serial I/O port of the remote terminal unit.

43. The wireless communication system of claim 42, further comprising a remotely located receiver.

44. The data concentrator of claim 41, wherein the memory unit includes an address range that stores a value indicating a span of time having elapsed since one of the pins within one of the plurality of latches last changed its state.

45. The data concentrator of claim 41, wherein the state of one of the pins within one of the plurality of latches is selected from the group consisting of logic high, logic low, and square wave.

46. The data concentrator of claim 45, wherein the act of detecting a change of state on one of the pins within one of the plurality of latches comprises determining that the one pin exhibits a particular state for a duration of at least one-and-a-half cycles of the square wave.
